(19) United States
(12) Patent Application Publication
(10) Pub. No.: US 2022/0136833 A1
(43) Pub. Date: May 5, 2022

(54) Latitude-Free Construction Method for Gravity Acceleration Vector Under Swaying base Earth System

(71) Applicant: Harbin Institute of Technology, Harbin (CN)

(72) Inventors: Guochen Wang, Harbin (CN); Ya Zhang, Harbin (CN); Zicheng Wang, Harbin (CN); Hongze Gao, Harbin (CN); Yanyan Wang, Harbin (CN); Chao Liu, Harbin (CN); Jianbo Shao, Harbin (CN); Jingchun Li, Harbin (CN)

(21) Appl. No.: 17/236,254

(22) Filed: Apr. 21, 2021

(30) Foreign Application Priority Data
Aug. 20, 2020 (CN) 2020108406108

(51) Int. Cl. G01C 21/16

(52) U.S. Cl. CPC G01C 21/16

(57) ABSTRACT

The present disclosure discloses a latitude-free construction method for a gravity acceleration vector under a swaying base earth system. Firstly, a target function based on output information of an accelerator in a fixed-length sliding window under a swaying base is constructed; secondly, measurement information in a period of time window is used to construct the target function, and gradient descent optimization is used to obtain a rough value of qᵢⁱ^{_{b0}}; and finally, the rough value of qᵢⁱ^{_{b0}} and an apparent motion of a gravity acceleration vector of an inertial system are used to construct the gravity acceleration vector under the earth coordinate system. The present disclosure makes a key breakthrough for solving the problem of high precision alignment of a ship with unknown latitude under a swaying base.

### TECHNICAL FIELD

The present disclosure relates to the technical field of strapdown inertial navigation, and particularly relates to a latitude-free construction method for a gravity acceleration vector under a swaying base earth system.

### BACKGROUND

A strapdown attitude heading reference system uses a gyroscope and an accelerometer to measure an angular velocity of motion and linear acceleration information of a carrier, and can continuously output horizontal attitudes and heading information of the carrier in real time after calculation. It has the advantages of small volume, fast start-up, high autonomy, high accuracy of attitude measurement and the like, and is widely used as an attitude reference of a combat unit such as a combat vehicle, a vessel and various weapon platforms.

An initial alignment technology is a key technology of the strapdown attitude heading reference system, and an alignment speed and alignment accuracy thereof will directly determine the start-up response time and attitude measurement accuracy of the strapdown attitude heading reference system. The traditional initial alignment technology does not require longitude information when starting alignment, but it relies heavily on external latitude information, which will reduce the autonomy and security of the system and affect its battlefield survivability. This effect is more significant under a swaying base.

Under the case of the swaying base, an angular velocity caused by a swaying motion of sea waves is much greater than an angular velocity of rotation of the earth, so that a gyroscope output have a lower signal-to-noise ratio, and it is impossible to directly extract an angular velocity vector of rotation of the earth from the gyroscope output information. At this time, a traditional analytical static base alignment method will not work. In addition, since the compass alignment and Kalman filter combination alignment method needs to meet the condition that a misalignment angle is a small angle when applied, initial alignment of arbitrary azimuth and heading angle of a swaying base cannot be completed.

Although it is not possible to directly use the angular velocity of rotation of the earth to construct a constraint equation under the case of the swaying base, an inertial system alignment method uses gravity acceleration vectors under an inertial system at two or more moments to construct corresponding constraint relations to determine an attitude transformation matrix, so that this method is widely applied to initial alignment of the swaying base. However, this alignment method still relies on the external latitude information, which will greatly limit the mission completion of the strapdown attitude heading reference system under conditions such as the loss of lock and rejection of a surface GPS signal and the inability to receive a positioning signal in water. Using an apparent motion of the gravity acceleration vector of the inertial system and related constraint relations to replace the latitude information to construct a gravity acceleration vector model under the earth system may solve this problem. Therefore, how to construct a latitude-free gravity acceleration vector will be a key process to solve this problem.

In view of the above problems, a latitude-free construction method for a gravity acceleration vector under a swaying base earth system is provided. This method makes full use of measurement information in a period of time window to construct a target function to obtain a rough value of qᵢⁱ^{_{b0}}, then uses an apparent motion of a gravity acceleration vector of an inertial system to construct a gravity acceleration vector under the earth coordinate system, and has higher noise suppression capacity, thus laying a foundation for solving the problem of high-precision alignment with unknown latitude of a ship under the case of the swaying base.

### SUMMARY

The present disclosure is directed to provide a construction method for a gravity acceleration vector with unknown latitude.

A technical solution for achieving the objective of the present disclosure is: a latitude-free construction method for a gravity acceleration vector under a swaying base earth system, including the following steps:

step I: establishing a target function based on output information of an accelerator in a fixed-length sliding window under a swaying base;

step II: constructing the target function by using measurement information in a period of time window;

step III: obtaining a rough value of qᵢⁱ^{_{b0}} by using gradient descent optimization;

step IV: constructing the gravity acceleration vector under the earth coordinate system by using the rough value of qᵢⁱ^{_{b0}} and an apparent motion of a gravity acceleration vector of an inertial system.

At step I, establishing the target function based on the output information of the accelerator in the fixed-length sliding window is as follows:

$$\begin{matrix}Vec ( F ( {t}_{kj} ) N ( {q}_{i}^{{i}_{{b}_{0}}} ) {q}_{e}^{i} ( {t}_{kj} ) ) = ( {( {q}_{e}^{i} ( {t}_{kj} ) )}^{T} ⊙ F ( {t}_{kj} ) ) Vec ( N ( {q}_{i}^{{i}_{{b}_{0}}} ) ) \\ = {q}_{0}^{ei} ( Δ {t}_{kj} ) F ( {t}_{kj} ) {N}_{1} + {q}_{3}^{ei} ( Δ {t}_{kj} ) F ( {t}_{kj} ) {N}_{4} \\ = [ {q}_{0}^{ei} ( Δ {t}_{kj} ) F ( {t}_{kj} ) {q}_{3}^{ei} ( Δ {t}_{kj} ) F ( {t}_{kj} ) ] [ \begin{matrix}{N}_{1} \\ {N}_{4}\end{matrix} ] \\ = 0\end{matrix} .$$

At step II, the measurement information in a period of time window is used to suppress noise interference of devices, and the following target function is constructed:

$${min}_{{q}_{i}^{{i}_{{b}_{0}}}} ζ ( A ( {t}_{kj} ) , X ) = \frac{1}{2} {\sum }_{k , j} {‖ A ( {t}_{kj} ) X ‖}^{2}$$

where A(tₖⱼ)=[q₀^{ei}(Δtₖⱼ)F(tₖⱼ)q₃^{ei}(Δtₖⱼ)F(t^{kj})], X[N₁N₄]^{T}

At step III, the rough value of qᵢⁱ^{_{b0}} is obtained by using the gradient descent optimization:

$${q}_{i}^{{i}_{{b}_{0}}} ( k ) = {q}_{i}^{{i}_{{b}_{0}}} ( k - 1 ) - λ ( k ) \frac{∇ ζ ( {A}_{k} , X )}{‖ ∇ ζ ( {A}_{k} , T ) ‖}$$

$$∇ ζ ( {A}_{k} , X ) = \frac{\partial {X}^{T}}{\partial {q}_{i}^{{i}_{{b}_{0}}}} {\sum }_{k} ( {A}_{k}^{T} {A}_{k} ) X$$

where ∇ζ(Aₖ,X) represents a gradient vector of the target function ζ(Aₖ,X), λ(k) represents a step length of the k th iteration, and an initial value of iteration is qᵢⁱ^{_{b0}}(0)=[1 0 0]^{T}.

At step VI, a projection of the gravity acceleration vector under the earth coordinate system e is constructed by using \tilde{f}^{i′}(tⱼ), and is recorded as \tilde{g}^{e}, as shown below:

$${\tilde{g}}^{e} = {[ - \sqrt{1 - {( \frac{1}{m} {\sum }_{j = {j}_{1}}^{{j}_{m}} {\tilde{f}}_{z}^{″} ( {t}_{j} ) )}^{2}} 0 - \frac{1}{m} {\sum }_{j = {j}_{1}}^{{j}_{m}} {\tilde{f}}_{z}^{{i}^{′}} ( {t}_{j} ) ]}^{T} .$$

Compared with the prior art, the present disclosure has the following beneficial effects:

In the case that the latitude is unknown, the present disclosure makes full use of the measurement information in a period of time window to construct the target function to obtain the rough value of qᵢⁱ^{_{b0}}, then uses the apparent motion of the gravity acceleration vector of the inertial system to construct the gravity acceleration vector under the earth coordinate system, and has higher noise suppression capacity, thus laying a foundation for solving the problem of high-precision alignment with unknown latitude of a ship under the case of the swaying base.

### BRIEF DESCRIPTION OF FIGURES

FIG. 1 is a schematic diagram of setting a fixed-interval-length sliding window.

### DETAILED DESCRIPTION

The present disclosure is further described below in combination with accompanying drawings.

First of all, under the condition of a pure swaying base, a specific force vector output by an accelerator under a b system is equal to a gravity acceleration vector in magnitude and is opposite to the gravity acceleration vector in direction, a normalization form of which is recorded as:

\tilde{f}b(tₖ)=[\tilde{f}ₓ^{b}(tₖ)\tilde{f}_{y}^{b}(tₖ))\acute{f}_{z}^{b}(tₖ)]^{T}.

The specific force vector output by the accelerator is converted from a b system to a i_{b}_{₀} system, written as:

\tilde{f}ⁱ^{_{b0}}(tₖ)=q_{b}ⁱ^{_{b0}}(tₖ)⊗\tilde{f}^{b}(tₖ)⊗q_{b}ⁱ^{_{b0}}*(tₖ).

For investigation at the t=t₀ moment, since qᵢⁱ^{_{b0}}(t₀)=[1 0 0 0]^{T}, it can get:

\tilde{f}ⁱ^{_{b0}}(t₀)=\tilde{f}^{b}(t₀).

In addition, an output value \tilde{f}ⁱ^{_{b0}} of the accelerator under the i_{b0} system is converted to the i, which can be denoted as:

\tilde{f}ⁱ(tₖ)=qᵢ_{_{b0}}ⁱ⊗\tilde{f}ⁱ^{_{b0}}(tₖ)⊗qᵢⁱ^{_{b0}}*.

Therefore, at the t=t₀ moment, it can get that:

$$\begin{matrix}{\tilde{f}}^{i} ( {t}_{0} ) = {q}_{{i}_{{b}_{0}}}^{i} ⊗ {\tilde{f}}^{b} ( {t}_{0} ) ⊗ {q}_{{i}_{{b}_{0}}}^{{i}^{*}} \\ = {\tilde{f}}^{e}\end{matrix}$$

where \tilde{f}^{e} represents a projection of the output value of the accelerator under the e system.

At this time, it can get that:

$$\begin{matrix}{\tilde{f}}^{{ib}_{0}} ( {t}_{k} ) = {q}_{i}^{{i}_{{b}_{0}}} ⊗ {q}_{e}^{i} ( {t}_{k} ) ⊗ {\tilde{f}}^{e} ⊗ {q}_{e}^{{i}^{*}} ( {t}_{k} ) ⊗ {q}_{i}^{{i}_{{b}_{0}}^{*}} \\ = {q}_{i}^{{i}_{{b}_{0}}} ⊗ {q}_{e}^{i} ( {t}_{k} ) ⊗ {q}_{{i}_{{b}_{0}}}^{i} ⊗ {\tilde{f}}^{b} ( {t}_{0} ) ⊗ {q}_{{i}_{{b}_{0}}}^{{i}^{*}} ⊗ {q}_{e}^{{i}^{*}} ( {t}_{k} ) ⊗ {q}_{i}^{{i}_{{b}_{0}}^{*}}\end{matrix} .$$

In order to simplify the operation, it is set that M_{q}=gᵢⁱ^{_{b0}}⊗qₑⁱ(tₖ)⊗qᵢ_{_{b0}}ⁱ_{, and the above formula can be rewritten as:}

\tilde{f}ⁱ^{_{b0}}(tₖ)=M_{q}⊗\tilde{f}^{b}(t₀)⊗M*_{q}

M_{q} is still a unit quaternion according to the quaternion multiplication chain rule. Therefore, two sides of the above formula are respectively subjected to postmultiplication with M_{q}, and it is get that:

\tilde{f}ⁱ^{_{b0}}(tₖ)⊗M_{q}=\tilde{f}^{b}(t₀)⊗M_{q}

([\tilde{f}ⁱ^{_{b0}}(tₖ)⊗]−[\tilde{f}^{b}(t₀)⊗])M_{q}=0

In addition, the quarternion M_{q} is investigated to get:

$$\begin{matrix}{M}_{q} = {q}_{i}^{{i}_{{b}_{0}}} ⊗ {q}_{e}^{i} ( {t}_{k} ) ⊗ {q}_{{i}_{{b}_{0}}}^{i} \\ = [ {q}_{i}^{{i}_{{b}_{0}}} ⊗ ] ( {q}_{e}^{i} ( {t}_{k} ) ⊗ {q}_{{i}_{{b}_{0}}}^{i} ) \\ = ( [ {q}_{i}^{{i}_{{b}_{0}}} ⊗ ] [ {q}_{i}^{{i}_{{b}_{0}}^{*}} ⊕ ] ) {q}_{e}^{i} ( {t}_{k} )\end{matrix}$$

If it is recorded that qᵢⁱ^{_{b0}}=[q₀ q₁ q₂ q₃]^{T},N(qᵢⁱ^{_{b0}})=([qᵢⁱ^{_{b0}}⊗][qᵢⁱ^{_{b0}}*⊗]), N(qᵢⁱ^{_{b0}}) is expanded as:

$$\begin{matrix}N ( {q}_{i}^{{i}_{{b}_{0}}} ) = [ \begin{matrix}1 & \# & \# & 0 \\ 0 & \# & \# & 2 ( {q}_{0} {q}_{2} + {q}_{1} {q}_{3} ) \\ 0 & \# & \# & 2 ( {q}_{2} {q}_{3} - {q}_{0} {q}_{1} ) \\ 0 & \# & \# & {q}_{0}^{2} - {q}_{1}^{2} - {q}_{2}^{2} + {q}_{3}^{2} )\end{matrix} ] \\ = [ {N}_{1} {N}_{2} {N}_{3} {N}_{4} ]\end{matrix}$$

where Nᵢ=1,2,3,4) represents an ith column of vectors of N(qᵢⁱ^{_{b0}}) and # represents that the value here is not required. Since the second column and third column of vectors do not affect later operation results, N₂ and N₃ do not need to be further investigated.

In addition, the quarternion qₑⁱ(tₖ) can be denoted as:

$$\begin{matrix}{q}_{e}^{i} ( {t}_{k} ) = cos ( \frac{{ω}_{ie} Δ {t}_{k}}{2} ) + \vec{z} sin ( \frac{{ω}_{ie} Δ {t}_{k}}{2} ) \\ = {[ cos ( \frac{{ω}_{ie} Δ {t}_{k}}{2} ) 0 \; 0 sin ( \frac{{ω}_{ie} Δ {t}_{k}}{2} ) ]}^{T}\end{matrix}$$

where Δtₖ=tₖ−t₀. It should be noted that an x axis component and a y axis component of the vector part in gₑⁱ(tₖ) are zero. Therefore, in order to simplify the operation, the quarternion Δtₖ=tₖ−t₀ can be written as:

qₑⁱ(tₖ)=[q₀^{ei}(tₖ)0 0 q₃^{ei}(tₖ)]^{T.}

Further, it is recorded that F(tₖ)=([\tilde{f}ⁱ^{_{b0}}(tₖ)⊗]−[\tilde{f}^{b}(t₀)⊗]), then:

F(tₖ)N(qᵢⁱ^{_{b0}})qₑⁱ(tₖ)=0.

Meanwhile, the Kronecker product algorithm in the matrix theory is used, and it can be obtained by sorting out from the above formula:

$$\begin{matrix}Vec ( F ( {t}_{k} ) N ( {q}_{i}^{{i}_{{b}_{0}}} ) {q}_{e}^{i} ( {t}_{k} ) ) = ( {( {q}_{e}^{i} ( {t}_{k} ) )}^{T} ⊙ F ( {t}_{k} ) ) Vec ( N ( {q}_{i}^{{i}_{{b}_{0}}} ) ) \\ = 0\end{matrix}$$

where Vec(⋅) represents an operation for expanding the matrix into columns and forming column vectors, and ⊙ represents the Kronecker product algorithm.

Since the x axis component and the y axis component of the vector part in the quarternion qₑⁱ(tₖ) are zero, the item (qₑⁱ(tₖ))^{T}⊙F(tₖ) in the above formula is expanded according to a Kronecker product to obtain:

(qₑⁱ(tₖ))^{T}└F(tₖ)=[q₀^{ei}(tₖ)F(tₖ)0 0 q₃^{ei}(tₖ)F(tₖ)].

Therefore, it can get in combination with the above several formulas:

$$\begin{matrix}Vec ( F ( {t}_{k} ) N ( {q}_{i}^{{i}_{{b}_{0}}} ) {q}_{e}^{i} ( {t}_{k} ) ) = ( {( {q}_{e}^{i} ( {t}_{k} ) )}^{T} ⊙ F ( {t}_{k} ) ) Vec ( N ( {q}_{i}^{{i}_{{b}_{0}}} ) ) \\ = {q}_{0}^{ei} ( {t}_{k} ) F ( {t}_{k} ) {N}_{1} + {q}_{3}^{ei} ( {t}_{k} ) F ( {t}_{k} ) {N}_{4} \\ = [ {q}_{0}^{ei} ( {t}_{k} ) F ( {t}_{k} ) {q}_{3}^{ei} ( {t}_{k} ) F ( {t}_{k} ) ] [ \begin{matrix}{N}_{1} \\ {N}_{4}\end{matrix} ] \\ = 0\end{matrix} .$$

It is recorded that X=[N₁N₄]^{T}. In order to reduce the interference of noise of devices to the output information of inertia devices, the measurement information in a period of time window is used to calculate the least square solution of the above formula. If it is recorded that A^{k}=[q₀^{ei}(tₖ)F(tₖ)q₃^{ei}(tₖ)F(tₖ)], a target function to be optimized that can be obtained from the above formula is as follows:

$${min}_{{q}_{i}^{{i}_{{b}_{0}}}} ζ ( {A}_{k} , X ) = \frac{1}{2} {\sum }_{k} {‖ {A}_{k} X ‖}^{2} .$$

Therefore, a gradient descent optimization method is used to solve the target function to obtain a rough value solution of qᵢⁱ^{_{b0}}. An iteration process of gradient descent optimization is as follows:

$${q}_{i}^{{i}_{{b}_{0}}} ( k ) = {q}_{i}^{{i}_{{b}_{0}}} ( k - 1 ) - λ ( k ) \frac{∇ ζ ( {A}_{k} , X )}{‖ ∇ ζ ( {A}_{k} , T ) ‖}$$

$$∇ ζ ( {A}_{k} , X ) = \frac{\partial {X}^{T}}{\partial {q}_{i}^{{i}_{{b}_{0}}}} {\sum }_{k} ( {A}_{k}^{T} {A}_{k} ) X$$

where ∇ζ(Aₖ,X) represents a gradient vector of the target function ζ(Aₖ,X), λ(k) represents a step length of the k th iteration, and an initial value of iteration is qᵢⁱ^{_{b0}}(0)=[1 0 0]^{T}.

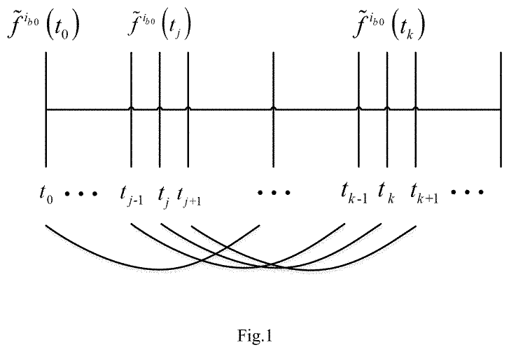

In order to suppress the pollution of outliers and noise interference to the initial time \tilde{f}^{b}(t₀), the target function constructed by the output information of the accelerometer is further improved, and the target function is established based on the output information of the accelerometer in the fixed-length sliding window, wherein the schematic diagram of setting of the sliding window is as shown in FIG. 1.

According to the above analysis, for any moment t=tₖ, there is:

$$\begin{matrix}{\tilde{f}}^{e} = {q}_{e}^{{i}^{*}} ( {t}_{k} ) ⊗ {\tilde{f}}^{i} ( {t}_{k} ) ⊗ {q}_{e}^{i} ( {t}_{k} ) \\ = {q}_{e}^{{i}^{*}} ( {t}_{k} ) ⊗ {q}_{{i}_{{b}_{0}}}^{i} ⊗ {\tilde{f}}^{{i}_{{b}_{0}}} ( {t}_{k} ) ⊗ {q}_{{i}_{{b}_{0}}}^{{i}^{*}} ⊗ {q}_{e}^{i} ( {t}_{k} )\end{matrix}$$

where \tilde{f}ⁱ, \tilde{f}^{e} represents projections of the output value of the accelerator under the i system and the e system.

For any two different moments t=tₖ and t=tⱼ (it is supposed that tₖ>tⱼ), there is:

$$\begin{matrix}{\tilde{f}}^{{i}_{{b}_{0}}} ( {t}_{k} ) = {q}_{i}^{{i}_{{b}_{0}}} ⊗ {q}_{e}^{i} ( {t}_{k} ) ⊗ {\tilde{f}}^{e} ⊗ {q}_{e}^{{i}^{*}} ( {t}_{k} ) ⊗ {q}_{i}^{{i}_{{b}_{0}}^{*}} \\ = M ( {t}_{kj} ) ⊗ {\tilde{f}}^{{i}_{{b}_{0}}} ( {t}_{j} ) ⊗ {M}^{*} ( {t}_{kj} )\end{matrix}$$

where M(tₖⱼ)=qᵢⁱ^{_{b0}}⊗qₑⁱ(tₖ)⊗qₑⁱ*(tⱼ)⊗qᵢ_{_{b0}}ⁱ.

Two sides of the above formula are respectively multiplied with M(tₖⱼ), and it can get that:

\tilde{f}^{ib}^{₀}(tₖ)⊗M(tₖⱼ)⊗\tilde{f}^{ib}^{₀}(tⱼ)

([\tilde{f}ⁱ^{_{b0}}(tₖ)⊗]−[\tilde{f}^{ib}^{₀}(tⱼ)⊗])M(tₖⱼ)=0

the quarternion M(tₖⱼ) can be sorted out according to the quaternion multiplication algorithm:

$$\begin{matrix}M ( {t}_{kj} ) = {q}_{i}^{{i}_{{b}_{0}}} ⊗ {q}_{e}^{i} ( {t}_{k} ) ⊗ {q}_{e}^{{i}^{*}} ( {t}_{j} ) ⊗ {q}_{{i}_{{b}_{0}}}^{i} \\ = [ {q}_{i}^{{i}_{{b}_{0}}} ⊗ ] ( Δ {q}_{e}^{i} ( {t}_{kj} ) ⊗ {q}_{{i}_{{b}_{0}}}^{i} ) \\ = ( [ {q}_{i}^{{i}_{{b}_{0}}} ⊗ ] [ {q}_{i}^{{i}_{{b}_{0}}^{*}} ⊕ ] ) Δ {q}_{e}^{i} ( {t}_{kj} )\end{matrix} .$$

Similarly, Δqₑⁱ(tₖⱼ) can be written as:

Δqₑⁱ(tₖⱼ)=[q₀^{ei}(Δtₖⱼ)0 0 q₃^{ei}(Δtₖⱼ)]^{T}

If it is recorded that F(tₖⱼ)=([\tilde{f}ⁱ^{_{b0}}(tₖ)⊗]−[\tilde{f}ⁱ^{_{b0}}(tⱼ)⊗]), then:

F(tₖⱼ)N(qᵢⁱ^{_{b0}})Δqₑⁱ(tₖⱼ)=0.

Further, the above formula can be sorted out according to the Kronecker product algorithm:

$$\begin{matrix}Vec ( F ( {t}_{kj} ) N ( {q}_{i}^{{i}_{{b}_{0}}} ) {q}_{e}^{i} ( {t}_{kj} ) ) = ( {( {q}_{e}^{i} ( {t}_{kj} ) )}^{T} ⊙ F ( {t}_{kj} ) ) Vec ( N ( {q}_{i}^{{i}_{{b}_{0}}} ) ) \\ = {q}_{0}^{ei} ( Δ {t}_{kj} ) F ( {t}_{kj} ) {N}_{1} + {q}_{3}^{ei} ( Δ {t}_{kj} ) F ( {t}_{kj} ) {N}_{4} \\ = [ {q}_{0}^{ei} ( Δ {t}_{kj} ) F ( {t}_{kj} ) {q}_{3}^{ei} ( Δ {t}_{kj} ) F ( {t}_{kj} ) ] [ \begin{matrix}{N}_{1} \\ {N}_{4}\end{matrix} ] \\ = 0\end{matrix} .$$

In the same way, the measurement information in a period of time window is used to suppress noise interference of the devices, and the following target function is constructed:

$${min}_{{q}_{i}^{{i}_{{b}_{0}}}} ζ ( A ( {t}_{kj} ) , X ) = \frac{1}{2} {\sum }_{k , j} {‖ A ( {t}_{kj} ) X ‖}^{2} .$$

Then the rough value of qᵢⁱ^{_{b0}} is obtained by using gradient descent optimization.

Further, the gravity acceleration vector \tilde{g}^{e} can be obtained:

$${\tilde{g}}^{e} = {[ - \sqrt{1 - {( \frac{1}{m} {\sum }_{j = {j}_{1}}^{{j}_{m}} {\tilde{f}}_{z}^{{i}^{′}} ( {t}_{j} ) )}^{2}} 0 - \frac{1}{m} {\sum }_{j = {j}_{1}}^{{j}_{m}} {\tilde{f}}_{z}^{{i}^{′}} ( {t}_{j} ) ]}^{T} .$$

What is claimed is:

1. A method of latitude-free construction for a gravity acceleration vector under a swaying base earth system, comprising the following steps:
step I: establishing a target function based on output information of an accelerator in a fixed-length sliding window under a swaying base;
step II: constructing the target function by using measurement information in a period of time window;
step III: obtaining a rough value of qᵢⁱ^{_{b0}} by using gradient descent optimization; and
step IV: constructing the gravity acceleration vector under the swaying base earth system by using the rough value of qᵢⁱ^{_{b0}} and an apparent motion of a gravity acceleration vector of an inertial system.

2. The method according to claim 1, wherein a method of establishing the target function based on the output information of the accelerator in the fixed-length sliding window in step I is:
$$\begin{matrix}Vec ( F ( {t}_{kj} ) N ( {q}_{i}^{{i}_{{b}_{0}}} ) {q}_{e}^{i} ( {t}_{kj} ) ) = ( {( {q}_{e}^{i} ( {t}_{kj} ) )}^{T} ⊙ F ( {t}_{kj} ) ) Vec ( N ( {q}_{i}^{{i}_{{b}_{0}}} ) ) \\ = {q}_{0}^{ei} ( Δ {t}_{kj} ) F ( {t}_{kj} ) {N}_{1} + {q}_{3}^{ei} ( Δ {t}_{kj} ) F ( {t}_{kj} ) {N}_{4} \\ = [ {q}_{0}^{ei} ( Δ {t}_{kj} ) F ( {t}_{kj} ) {q}_{3}^{ei} ( Δ {t}_{kj} ) F ( {t}_{kj} ) ] [ \begin{matrix}{N}_{1} \\ {N}_{4}\end{matrix} ] \\ = 0\end{matrix} .$$

3. The method according to claim 1, wherein a method of constructing the target function by using the measurement information in the period of time window in step II is:
$${min}_{{q}_{i}^{{i}_{{b}_{0}}}} ζ ( A ( {t}_{kj} ) , X ) = \frac{1}{2} {\sum }_{k , j} {‖ A ( {t}_{kj} ) X ‖}^{2} .$$
where A (tₖⱼ)=[q₀^{ei} (Δtₖⱼ)F(tₖⱼ)q₃^{ei}(Δtₖⱼ)F (tₖⱼ)], and X=[N₁N₄]^{T}.

4. The method according to claim 1, wherein a method of obtaining the rough value of qᵢⁱ^{_{b0}} by using the gradient descent optimization in step III is:
$${q}_{i}^{{i}_{{b}_{0}}} ( k ) = {q}_{i}^{{i}_{{b}_{0}}} ( k - 1 ) - λ ( k ) \frac{∇ ζ ( {A}_{k} , X )}{‖ ∇ ζ ( {A}_{k} , T ) ‖}$$
$$∇ ζ ( {A}_{k} , X ) = \frac{\partial {X}^{T}}{\partial {q}_{i}^{{i}_{{b}_{0}}}} {\sum }_{k} ( {A}_{k}^{T} {A}_{k} ) X$$
where ∇ζ⁻(Aₖ,X) represents a gradient vector of the target function ζ(Aₖ, X), λ(k) represents a step length of a k^{th} iteration, and an initial value of iteration is qᵢⁱ^{_{b0}} (0)=[1 0 0 0]^{T}.

5. The method according to claim 1, wherein a method of constructing the gravity acceleration vector under the swaying base earth system by using the rough value of qᵢⁱ^{_{b0}} and the apparent motion of the gravity acceleration vector of the inertial system in step IV is:
$${\tilde{g}}^{e} = {[ - \sqrt{1 - {( \frac{1}{m} {\sum }_{j = {j}_{1}}^{{j}_{m}} {\tilde{f}}_{z}^{″} ( {t}_{j} ) )}^{2}} 0 - \frac{1}{m} {\sum }_{j = {j}_{1}}^{{j}_{m}} {\tilde{f}}_{z}^{{i}^{′}} ( {t}_{j} ) ]}^{T} .$$
